(19) United States
(12) Patent Application Publication
(10) Pub. No.: US 2004/0110487 A1
(43) Pub. Date: Jun. 10, 2004

(54) Wireless network access system

(75) Inventors: Thomas E. Creamer, Boca Raton, FL (US); Neil A. Katz, Parkland, FL (US); Victor S. Moore, Boynton Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 10/314,711

(22) Filed: Dec. 9, 2002

(51) Int. Cl. H04M 11/00; H04M 1/66; H04M 1/68; H04M 3/16

(52) U.S. Cl. 455/411; 455/406

(57) ABSTRACT

A method for granting access to a wireless network can include receiving a connection request from a mobile computing device for access to a wireless network. The mobile computing device can be prompted for a telephone number. The telephone number can be contacted resulting in a connection response. The mobile computing device can be granted access to the wireless network according to the connection response.

### BACKGROUND OF THE INVENTION

1. Technical Field

The present invention relates to the field of networking devices and, more particularly, to granting wireless network services to mobile computing devices.

2. Description of the Related Art

Wireless network systems are currently being deployed in many diverse environments including schools, airports, convention centers, and even commercial establishments such as coffee shops. Providers of wireless networking systems benefit from high portability, scalability, and relatively low implementation cost as compared with conventional, wire based networks. Instead of being bound to a particular outlet, users of a wireless network can maintain network access while roaming anywhere within a coverage area of the wireless network. Additionally, increased safety results from utilizing wireless networks within areas of heavy traffic, as there are no cables on which people may stumble.

Despite the tremendous advantages of wireless network services, a few disadvantages remain. For example, providers of wireless network services have difficulties related to compensation. While wireless network systems can be more cost efficient to implement than their line constrained counterparts, substantial costs are still involved. These costs include purchase costs for the physical hardware for receiving and transmitting wireless signals, system maintenance costs, and line costs for the bandwidth necessary for connecting wireless traffic to a public network. Some cost recovery mechanism is needed so that providing wireless networks becomes a financially viable venture.

Establishing payment systems for users of wireless networks can be complicated by both the dynamic nature of the user population and the nature of the service itself. In many locations experiencing a high demand for wireless network connectivity, such as airports and coffee shops, potential users of wireless networks can be a dynamic group of transient individuals. Many potential users will frequent a particular location for only a brief period of time. Thus, conventional payment schemes, such as requiring memberships, can be extremely burdensome to service users and involve substantial overhead costs to the service provider. Furthermore, many users will not wish to be hassled with establishing a plurality of memberships for the multitude of places from which wireless network access would otherwise be desirable.

Another disadvantage relating to conventional wireless networks pertains to network security. With regard to wireless networks, typically unauthorized users have difficulty accessing hardware which is physically linked to a given trusted network, such as a company intranet. Computers granted full intranet access can be located behind locked doors or monitored by company employees. Unlike wired networks, the transmissions involved in wireless systems are substantially harder to cordon off than physical connections.

Worse, the existence of detection devices or “sniffers” designed to penetrate wireless systems create security complications. If static passwords are used within a wireless system, “sniffers” eavesdropping on a network can capture such passwords, thus gaining access to the otherwise trusted system. While many software based protection mechanisms exist to assure that only authorized personnel are granted access to wireless networks, some additional physical constraint on wireless connectivity would result in substantial security gains.

### SUMMARY OF THE INVENTION

The invention disclosed herein provides a method and a system for providing wireless network access. In particular, the method requires a user of a mobile computing device desiring access to a wireless network to provide a telephone number. This number can then be used to contact a telephone device. Subsequently, a user of the telephone device verifies the wireless access request and agrees to payment conditions. Upon receipt of this agreement, the wireless network grants access to the mobile computing device.

One aspect of the present invention can include a method for granting access to a wireless network. The method can include receiving a connection request from a mobile computing device for access to the wireless network. The mobile computing device can be prompted for a telephone number. Next, this telephone number can be used to contact an associated telephone device. Optionally, before the telephone number is contacted, the method can query for user information based on the telephone number. This query can be used to disqualify some users, such as those with outstanding account balances, before connection is established or to offer frequent users of the wireless network a special rate. Notably, the telephone device can be a cellular telephone. Moreover, the telephone device and the mobile computing device can be integrated, i.e., the same device. For example, both the mobile computing device and telephone device can be a laptop computer with a modem connection for receiving telephone calls.

Upon contacting the telephone device, the method can receive a connection response from the telephone device associated with the telephone number. Possible connection responses can include, but are not limited to, a user voice response, a keypad entry, and a browser response. Additionally, the connection response can be a completely automated response requiring no human interaction. Alternatively, the method can involve human callers contacting a human user using the telephone device, thusly requiring extensive human interaction.

In addition to requiring a connection response, the method can present billing information for accessing the wireless network. The method can receive an authorization response from the telephone device, wherein the authorization response denotes a willingness to pay a billing amount specified within the billing information. Should the authorization response be negative, wireless network access can be denied.

In one embodiment, assuming a positive authorization response, the method can charge the billing amount to a service account associated with telephone device, such as a cellular telephone account. In another embodiment, the method can charge the billing amount to an account local to the wireless network, thusly requiring the owner of the local wireless network to perform collection tasks. Alternatively, the method can prompt a user of the telephone device for an authorized billing account, such as a credit card, to which charges for the wireless local network can be applied. Upon receiving the authorized billing account information, the method can then charge the billing amount to the authorized billing account. Notably, the method can provide the mobile computing device access to the wireless network according to the connection and authorization responses.

Another aspect of the present invention can include a system for providing wireless network access. The system can include an access server configured to provide access to a public network and a wireless access point configured to transport data between a wireless computing device and the access server. For example, the wireless computing device, such as a laptop computer, can be connected to the access server using an 802.11 compliant protocol. The system can also include an application server that can be configured to transmit a connection request to a telephone device and receive a connection response from the telephone device. Notably, access to the access server through the wireless access point can be dependant upon the connection response. Additionally, the system can include an authentication server for authenticating the connection response and authorizing access to the access server. Moreover, the system can include a billing repository for determining access charges.

### BRIEF DESCRIPTION OF THE DRAWINGS

There are shown in the drawings embodiments, which are presently preferred, it being understood, however, that the invention is not limited to the precise arrangements and instrumentalities shown.

FIG. 1 is a schematic diagram illustrating an exemplary wireless local area network access system in accordance with the inventive arrangements disclosed herein.

FIG. 2 is a flow chart illustrating a method of granting wireless access to a mobile computing device using the system of FIG. 1.

### DETAILED DESCRIPTION OF THE INVENTION

The invention disclosed herein provides a method and a system for providing wireless network access. The system utilizes a telephone device to facilitate billing for wireless network access granted to a mobile computing device. In particular, the method requires a user of the mobile computing device to provide a telephone number. The provided number can then be called, resulting in the telephone device being contacted. This telephone device can be queried concerning connectivity terms for the wireless service. If the telephone device signals an agreement to the connectivity terms, wireless network access can be granted to the mobile computing device.

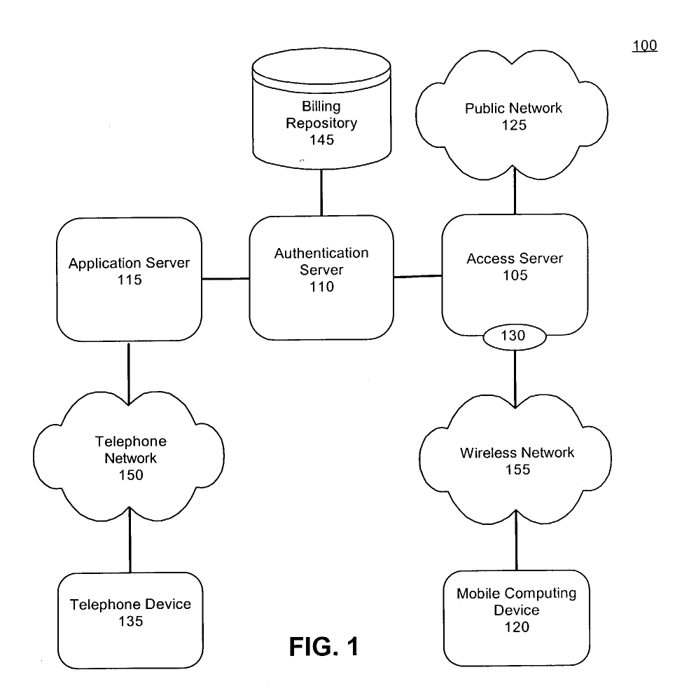

FIG. 1 is a schematic diagram of a system 100 illustrating an exemplary wireless local area network access system in accordance with the inventive arrangements disclosed herein. As shown in FIG. 1, the system 100 can include an access server 105, an authentication server 110, an application server 115, a public network 125, a mobile computing device 120, and a telephone device 135. The access server 105 can be any computing device capable of granting other computing devices access to the public network 125. For example, the access server 105 can be a stand alone computer as well as an intelligent routing device.

The public network 125 can represent a network that a user of the mobile computing device 120 ultimately seeks to access. The public network 125 can be any series of points or nodes connected by a series of interconnection paths. In one embodiment, the public network 125 can be the Internet. Alternately, the public network 125 can be a corporate intranet. In yet another embodiment, the public network 125 can be a group of interconnected users interactively accessing an application, such as a networked computer game.

The mobile computing device 120 can be the device capable of accessing a wireless network 155. The mobile computing device 120 can include, but is not limited to, notebook computers, personal data assistants, or any other device which can connect to a wireless network. Notably, such a device can be disposed within a larger system. For example, many vehicles include network connectable devices such as vehicle navigational systems. Additionally, the mobile computing device 120 can include a peripheral device, such as a wireless network interface card or an infrared port for connecting to other devices without a physical line connecting the devices.

The wireless network 155 can be the network connecting the mobile computing device 120 to the access server 105 through a wireless access point 130. The wireless network can follow many different protocols including the 802.11 family of specifications. The wireless access point 130 can include a hardware device capable of relaying the signals of the wireless network 155 between the access server 105 and one or more mobile computing devices.

The authentication server 110 can be a centralized location where all user identification information related to the system 100 accesses can be stored. For example, the authentication server can store a list of wireless users currently on the system. Additionally, the authentication server 110 can include a billing repository 145 that can contain records concerning user accounts. Notably, multiple application servers can access user information contained within the authentication server 110. Accordingly, better system security and policy maintenance is possible when utilizing the authentication server 110 than with systems that store access information within individual application servers. According to one embodiment, the authentication server 110 can, but need not, be implemented using the RADIUS (Remote Authentication Dial-In User Service) protocol.

The application server 115 can relay information to the telephone device 135 across a telephone network 150. The connection between the application server 115 and the telephone device 135 can be made using a telephone number provided by the mobile computing device 120. The application server 115 can host Interactive Voice Response (IVR) applications capable of processing inbound and outbound messages. In one embodiment, the application server 115 can dial the telephone device 135, thereafter communicating to the telephone device 135 user through IVR applications disposed within the application server 115. In another embodiment, the application server 115 can communicate with the telephone device 150 through a packet based protocol using protocols such as Wireless Application Protocol (WAP), Short Message Service (SMS), or Session Initiation Protocol (SIP) using IVR applications disposed within the server 115. Notably, IVR applications can accept a combination of voice and keypad selections and provide appropriate responses. Additionally, messages sent from the application server 115 can include both static messages and/or dynamically generated messages responsive to inputs received from the telephone device 135.

The telephone device 135 can include, but is not limited to, such devices as cellular telephones, personal data assistants, business telephones, home telephones, home computing appliances, pay telephones, and answering services. As defined herein, the telephone device 135 can be any device which can be associated with a phone number. For example, the telephone device 135 can be a PDA with online access that can access a data channel (linked to a telephone number) instead of a telephony channel. Notably, the telephone network 150 can include the Public Switched Telephone Network (PSTN) as well as packet switched telephony networks, and wireless networks including cellular networks.

Notably, the authentication server 110 need not be a standalone server, but can be incorporated within another device or set of devices, such as the application server 115 or the access server 105. Furthermore, the system 100 need not include an authentication server 110, but could instead handle user access functions at the access server 105 or the application server 115. Moreover, the billing repository 145 need not be a centralized repository, but can reside within multiple distributed computing devices or within the application server 115 or within the access server 105. Additionally, system 100 need not maintain a separate billing repository 145 at all. Instead, wireless network accesses can be automatically charged and paid for at the time of service through some external payment system, such as a credit card or a telephone service account.

One of ordinary skill in the art can appreciate that the application server 115 need not be an automated computing device as previously described. Instead, the application server 115 can be a manned call center which can contact a customer through the telephone device 135. Such an implementation can be advantageous for small businesses unable or unwilling to invest the capital necessary for an automated system. Additionally, in some business settings customers can be more responsive to human, as opposed to automated, interactions.

In operation, a user can connect the mobile computing device 120, such as a laptop computer, to the wireless network 155. The access server 105 can be configured to detect a connection and query a newly connected device, such as the mobile computing device 120. Then, the user is prompted via the laptop computer for a telephone number. The access server 105 can then relay the telephone number to the application server 115, which subsequently dials the telephone number. The user can answer the now ringing telephone device 135, such as a cellular telephone, which the user in this example possesses. Next, the application server 115 can convey the terms for accessing the wireless network 155 to the user through the telephone device 135. Upon agreement to the terms, signaled by voice or keypad response, the user's connection information can be verified by the authentication server 110. Upon verification, access to the mobile computing device 120 can be granted. Thereafter, the access server 105 can provide the mobile computing device 120 with access to the public network 125.

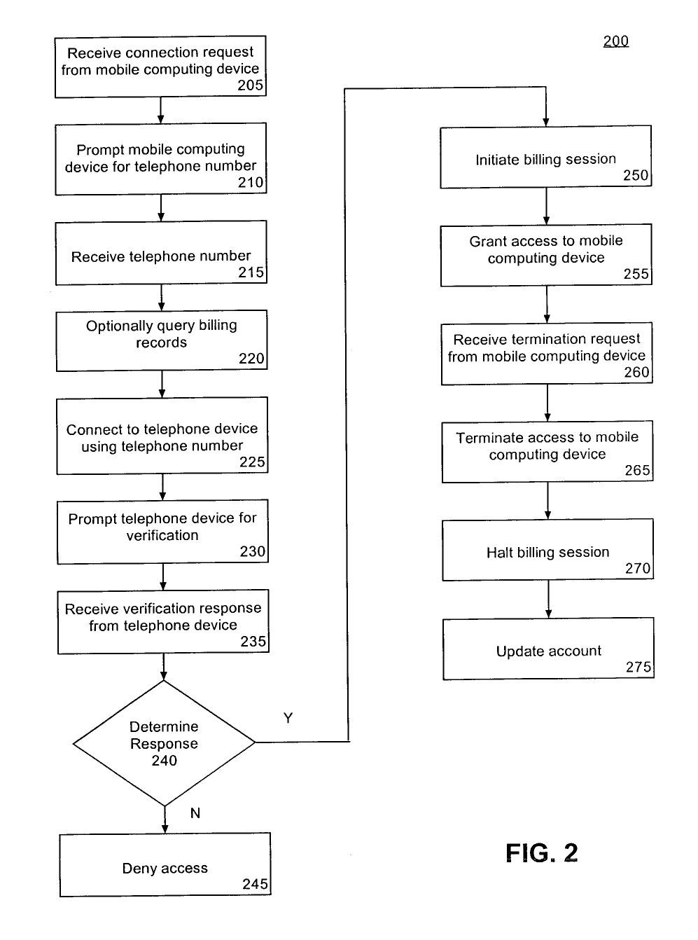

FIG. 2 is a flow chart illustrating a method 200 of granting wireless access to a mobile computing device using the system of FIG. 1. The method 200 can be performed in the context of wireless networking. More particularly, method 200 presupposes that a provider possesses a wireless network, such as an 802.11 compliant network and that the provider charges one or more users to access the wireless network. Additionally, a given user desiring access to the wireless network can possess a mobile computing device capable of interacting with the wireless network and has access to a telephone device.

The method can begin in step 205, where the provider receives a connection request. For example, the user can activate the mobile computing device and select the provider's network using connectivity options contained within the mobile computing device. In step 210, the user can be prompted for a telephone number. In one embodiment, this prompting can involve extensive human interaction, such as an agent verbally requesting a telephone phone number from a user. In another embodiment, the prompting can be automated. For example, in a particular embodiment, the wireless network can detect when a mobile computing device makes a connection attempt. Responsive to this connection attempt, a text box can appear within the mobile computing device requesting the telephone number. Alternately, a “cookie” or preconfigured software object located within the mobile computing device can supply the required telephone number when prompted. In step 215, the system receives the telephone number.

In step 220, the provider's system can optionally query billing records relating to a given telephone number. Notably, before such a query can be made, the provider's system must record user account information, which is itself optional. This query can serve multiple purposes. For example, the query can relate to a customer reward program for frequent users. In another example, the query can relate to providing discounted service or coupons to select users. On the other hand, the query can discover that the user has an excessive outstanding balance and refuse to grant wireless network access until the balance is paid.

In step 225, the presented telephone number can be contacted and a connection established with the telephone device. This connection can be established through a human agent, such as a call center employee, or through a computing device. In one embodiment, the telephone device belongs to the user requesting network access. In another embodiment, the telephone device can belong to a separate individual or company willing to take financial responsibility for the user's access expenses.

Notably, the connection device can be a cellular telephone that the user currently possesses. In one embodiment, contact with the telephone device can be established through dialing a telephone number. Alternately, the telephone device 150 can be contacted through a packet based protocol using protocols such as Wireless Application Protocol (WAP), Short Message Service (SMS), or Session Initiation Protocol (SIP). For example, a Web-enabled cellular telephone can communicate with WAP.

In step 230, the telephone device can be prompted for verification of user identity as well as agreement for costs associated with the solicited wireless network access. The type of prompting can be dependant upon the connection mechanism used. For example, if dialing was used to connect to the user, the user can be vocally prompted. Alternately, if WAP protocol was used to establish a connection, the prompting can occur through the telephone device's browser.

Furthermore, during this step, price information can be presented to the user either through the telephone device or through the mobile computing device. Additionally, the prompting can occur without substantial human interaction. For example, the telephone device can contain processing capabilities, such as programmable macros, capable of automatically responding to a verification request.

In step 235, the provider's system can receive a connection response from the telephone device. Such a response can include, but is not limited to, a user voice response, a keypad entry, and a browser response. The browser response can be transmitted in a plurality of manners including WAP, SMS, and SIP.

In step 240, the provider's system can interpret the connection response and take appropriate action. In one embodiment, a computing device can convert a verbal response to text, and interpret the text as a positive response. Notably, the response can be stored and recorded within the billing system as evidence of a contractual agreement. Should the response be hostile or not conform with the provider's requirements for service, wireless network access can be denied, as shown in step 245.

If the response determined in step 240 is positive, the method can proceed to step 250 where a billing session can be initiated. While initiating a billing session additional information may be required of the user. For example, the method can require an authorization response indicating the willingness for a given user to pay a specified billing amount. Should the authorization response be negative, wireless network access can be denied.

Additionally, different mechanisms can be utilized for charging a user for wireless network access. For example, the method can charge the billing amount to a service account associated with telephone device, such as a cellular telephone account. In another embodiment, the method can charge the billing amount to an account local to the wireless network, thusly requiring the owner of the local wireless network to perform collection tasks. Alternatively, the method can prompt a user of the telephone device for an authorized billing account, such as a credit card, to which charges for the wireless local network can be applied. Upon receiving the authorized billing account information, the method can then charge the billing amount to the authorized billing account. Notably, the method can provide the mobile computing device access to the wireless network according to the connection and authorization responses.

In step 255, wireless network access can be granted to the mobile computing device. Notably, different levels of access can be granted within a given network depending on user identity and payment options. For example, a wireless network may grant the user access to an electronic mail account and chat rooms at one rate and access to the entire Internet at a higher rate.

In step 260, the provider's system can receive a request to terminate a network connection. The termination request can, but need not, be transmitted from the mobile computing device. For example, a termination request can be submitted through the telephone device or through some agent of the provider. Moreover, the termination request need not originate from the user. Instead, the termination request can come from a system administrator, a fee paying source, such as an employer, or any authorized third party. Additionally, the termination request can result from a lack of system activity indicating a “time out” state or disconnection.

In step 265, the wireless connection with the mobile computing device can be terminated. Then, in step 270, the billing session can be halted. Since access billing may be dependant upon access time, the halting of the billing session can be significant. Notably, billing need not be based upon access time. Billing can, for example, be based on a flat rate or upon resource consumption. Consequently, in step 275, the user's billing account can be updated.

One skilled in the art should appreciate, that while the disclosed invention can contain many prompting steps, not all of these prompting steps require explicit interaction between the provider and the user. For example, a particular user may regularly visit a coffee shop that utilizes the disclosed invention. As a regular visitor, once the user begins setting up a notebook computer, the establishment manager can infer that the user desires access to a wireless network. In this example, the manager may shortcut the connection steps by automatically providing the customer's telephone number. Accordingly, a cellular telephone in possession of the user can be contacted before the invention prompts the customer's computer for the phone number. Similarly, other normally interactive steps within the disclosed invention can be conducted by an agent of the user instead of by the user directly.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for granting access to a wireless network comprising the steps of:
receiving a connection request from a mobile computing device for access to a wireless network;
prompting said mobile computing device for a telephone number;
contacting said telephone number;
receiving a connection response from a telephone device associated with said telephone number; and,
providing said mobile computing device access to said wireless network according to said connection response.

2. The method of claim 1, further comprising the steps of:
presenting billing information for accessing said wireless network; and,
receiving an authorization response from said telephone device, wherein said authorization response denotes a willingness to pay for local wireless connectivity.

3. The method of claim 2, further comprising the step of charging a service account associated with said telephone device for local wireless connectivity according to said authorization response.

4. The method of claim 2, further comprising the step of charging an account local to said wireless network for local wireless connectivity according to said authorization response.

5. The method of claim 2, further comprising the steps of:
prompting for an authorized billing account to which charges for said wireless local network can be applied;
receiving said authorized billing account information; and,
charging said billing amount to said authorized billing account according to said authorization response.

6. The method of claim 1, wherein said telephone device is a cellular device.

7. The method of claim 1, wherein said mobile computing device and said telephone device are the same device.

8. The method of claim 1, wherein said connection response is an automated response not requiring human interaction.

9. The method of claim 1, said method further comprising the step of querying for user information based on said telephone number.

10. The method of claim 1, wherein said connection response is selected from the group consisting of a user voice response, a keypad entry, and a browser response.

11. The method of claim 1, said method further comprising the step of prompting said telephone device for said connection response via an audio prompt provided over a telephony channel.

12. The method of claim 1, said method further comprising the step of prompting said telephone device for said connection response via a visual prompt provided over a data channel.

13. A system providing wireless network access comprising:
an access server configured to provide access to a public network;
a wireless access point configured to transport data between a wireless computing device and said access server; and,
an application server, configured to transmit a connection request to a telephone device and receive a connection response from said telephone device,
wherein access to said access server through said wireless access point is dependant upon said connection response.

14. The system of claim 13, further comprising an authentication server, wherein said authentication server authenticates said connection response and authorizes access to said access server.

15. The system of claim 13, wherein said wireless computing device is connected to said access server using an 802.11 compliant protocol.

16. The system of claim 13, said system further comprising a billing repository for determining access charges.

17. A machine readable storage having stored thereon, a computer program having a plurality of code sections, said code sections executable by a machine for causing the machine to perform the steps of:
receiving a connection request from a mobile computing device for access to a wireless network;
prompting said mobile computing device for a telephone number;
contacting said telephone number;
receiving a connection response from a telephone device associated with said telephone number; and,
providing said mobile computing device access to said wireless network according to said connection response.

18. The machine readable storage of claim 17, further comprising the steps of:
presenting billing information for accessing said wireless network; and,
receiving an authorization response from said telephone device, wherein said authorization response denotes a willingness to pay a for local wireless connectivity.

19. The machine readable storage of claim 18, further comprising the step of charging a service account associated with said telephone device for local wireless connectivity according to said authorization response.

20. The machine readable storage of claim 18, further comprising the step of charging an account local to said wireless network for local wireless connectivity according to said authorization response.

21. The machine readable storage of claim 18, further comprising the steps of:
prompting for an authorized billing account to which charges for said wireless local network can be applied;
receiving said authorized billing account information; and,
charging said billing amount to said authorized billing account according to said authorization response.

22. The machine readable storage of claim 17, wherein said telephone device is a cellular device.

23. The machine readable storage of claim 17, wherein said mobile computing device and said telephone device are the same device.

24. The machine readable storage of claim 17, wherein said connection response is an automated response not requiring human interaction.

25. The machine readable storage of claim 17, further comprising the step of querying for user information based on said telephone number.

26. The machine readable storage of claim 17, wherein said connection response is selected from the group consisting of a user voice response, a keypad entry, and a browser response.

27. The machine readable storage of claim 17, further comprising the step of prompting said telephone device for said connection response via an audio prompt provided over a telephony channel.

28. The machine readable storage of claim 17, further comprising the step of prompting said telephone device for said connection response via a visual prompt provided over a data channel.
